(19) United States
(12) Patent Application Publication
(10) Pub. No.: US 2016/0006883 A1
(43) Pub. Date: Jan. 7, 2016

(54) CHARGING ARCHITECTURE FOR A CONVERGED GATEWAY

(71) Applicant: INTERDIGITAL PATENT HOLDINGS, INC., Wilmington, DE (US)

(72) Inventor: John Cartmell, North Massapequa, NY (US)

(73) Assignee: InterDigital Patent Holdings, Inc., Wilmington, DE (US)

(21) Appl. No.: 14/768,821

(22) PCT Filed: Feb. 18, 2014
(86) PCT No.: PCT/US2014/016892

§ 371 Date: Aug. 19, 2015

Related U.S. Application Data
(60) Provisional application No. 61/766,460, filed on Feb. 19, 2013.

(51) Int. Cl. H04M 15/00

(52) U.S. Cl. CPC H04M 15/66; H04M 15/58; H04M 15/56; H04M 15/886; H04M 15/64; H04M 15/65

(57) ABSTRACT

Systems, methods, and instrumentalities are provided to implement charging, e.g., provide charging information associated with content provided to an end user (e.g., a wireless transmit/receive unit (WTRU)). A. gateway device may detect a request to a content provider. The gateway device may send the request to the content provider. The gateway device may send the request to the content provider via a non-cellular interface bypassing a core network. The gateway device may send an authorization message to the network. The gateway device may transmit the authorization message. The gateway device may receive an acknowledgement of the first authorization message from the PCRF entity, for example. The gateway device may receive traffic associated with the request from the content provider, e.g., via the non-cellular interface. The gateway device may send a charging message to a charging entity. The gateway device may send the traffic toward the WTRU.

### CROSS REFERENCE TO RELATED APPLICATIONS

This application claims the benefit of U.S. Provisional Patent Application No. 61/766,460, filed Feb. 19, 2013, the content of which is hereby incorporated by reference herein.

### BACKGROUND

In recent years the number of mobile networks and the mobile computing devices connecting to the mobile networks has increased rapidly. Mobile users may connect to the mobile networks over a licensed and/or an unlicensed spectrum to avail services provided by mobile network service providers. The mobile service providers may charge the mobile users for the various services. Current charging technologies used by mobile network service providers may be inadequate.

### SUMMARY

Systems, methods, and instrumentalities are provided to implement charging, e.g., provide charging information associated with content provided to an end user (e.g., a wireless transmit/receive unit (WTRU)). A gateway device (e.g., a converged gateway (CGW)) may detect a request to a content provider (e.g., a request from a WTRU for content, where the WTRU may be connected to a network, such as a cellular network). The gateway device may send the request to the content provider. The gateway device may send the request to the content provider bypassing a cellular core network. The gateway device may send an authorization message (e.g., an authentication and authorization (AA) request associated with the request) to the network (e.g., a PCRF entity in the core network). The gateway device may transmit the authorization message over an Rₓ interface. The gateway device may receive an acknowledgement of the first authorization message (e.g., an AA answer in response to the AA request) from the PCRF entity, for example. The gateway device may receive traffic associated with the request from the content provider, e.g., bypassing the cellular core network. The gateway device may send a charging message to a charging entity (e.g., the charging message may provide information to the network about the offloaded traffic associated with the delivered content). The gateway device may send the traffic toward the WTRU.

The gateway device may transmit a charging related message to an online charging system (OCS). The gateway device may transmit the charging related message via, e.g., a G_{y} interface. The gateway device may transmit another charging related message to an offline charging system (OFCS), e.g., via a Gₐ or R_{f} interface. The authorization message may comprise at least one of charging information, a wireless transmit/receive unit (WTRU) identity, a quality of service (QoS) requirement, or a spending limit.

The gateway device may receive a wireless transmit/receive unit (WTRU) detach message. The gateway device may transmit a credit control (CC) request indicating termination, e.g., over the G_{y} interface. The gateway device may receive a CC answer acknowledging the CC request indicating termination. The gateway device may transmit another CC request to a charging entity, and may receive a CC answer acknowledging the second CC request.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 illustrates an exemplary converged gateway system with local application function charging architecture.

FIG. 3 illustrates an exemplary message sequence chart (MSC) for the converged gateway system with local application function charging architecture of FIG. 2.

FIG. 4 illustrates an exemplary converged gateway system with local selected IP traffic offload (SIPTO) and local IP access (LIPA) charging architecture.

FIG. 5 illustrates an exemplary MSC for converged gateway system with local SIPTO and LIPA charging architecture of FIG. 4.

FIG. 6 illustrates an exemplary converged gateway system with local IP flow mobility (IFOM) charging architecture.

FIG. 7 illustrates an exemplary MSC for converged gateway system with local IFOM charging architecture of FIG. 6.

FIG. 8 illustrates an exemplary MSC for converged gateway system processing a wireless transmit/receive unit (WTRU) detach.

### DETAILED DESCRIPTION

A detailed description of illustrative embodiments will w be described with reference to the various figures. Although this description provides a detailed example of possible implementations, it should be noted that the details are intended to be exemplary and in no way limit the scope of the application. In addition, the figures may illustrate message sequence charts, which are meant to be exemplary. Other embodiments may be used. The order of the messages may be varied where appropriate. Messages may be omitted if not needed, and, additional flows may be added.

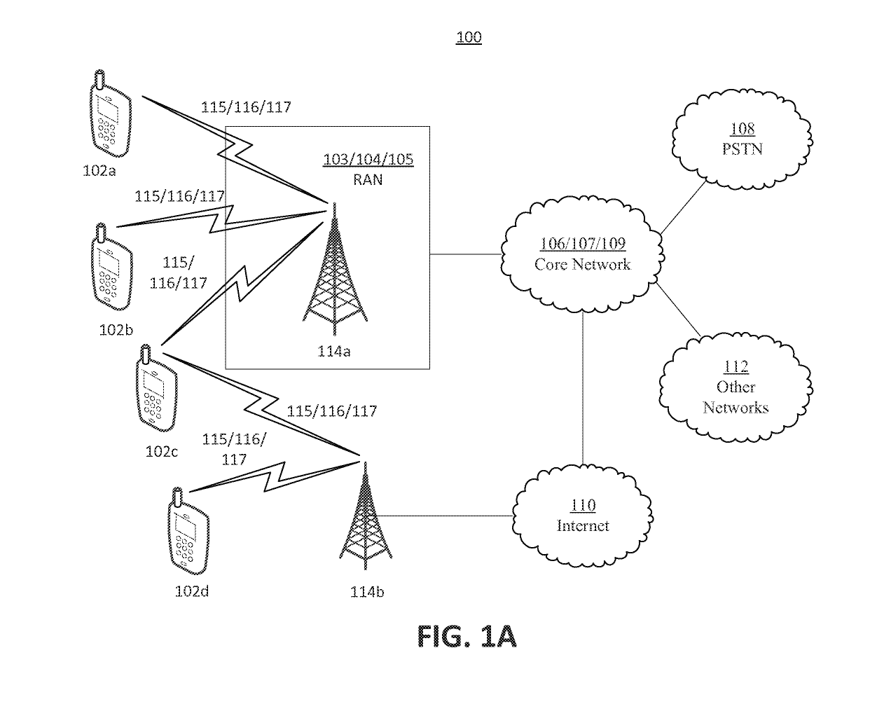

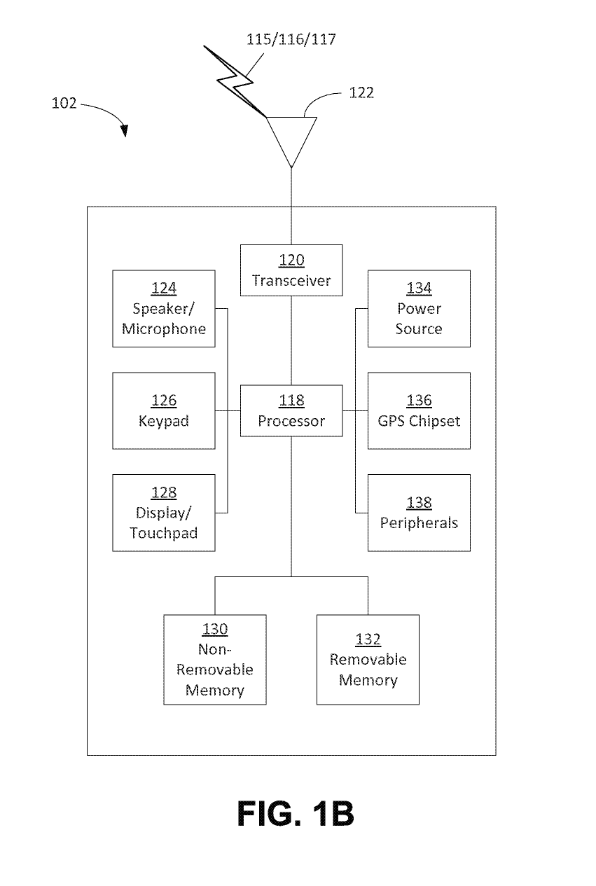

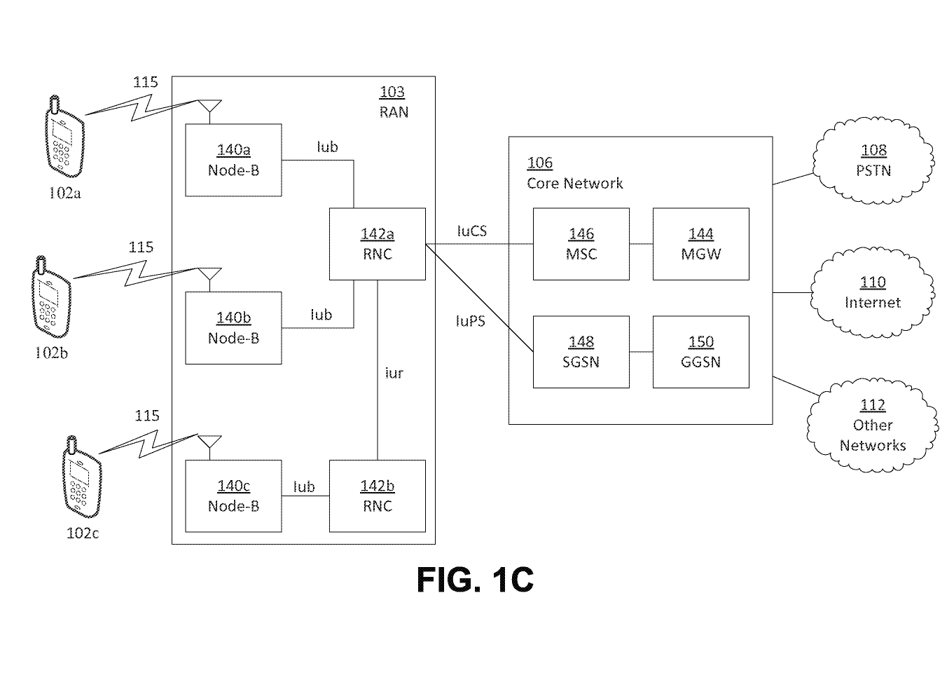

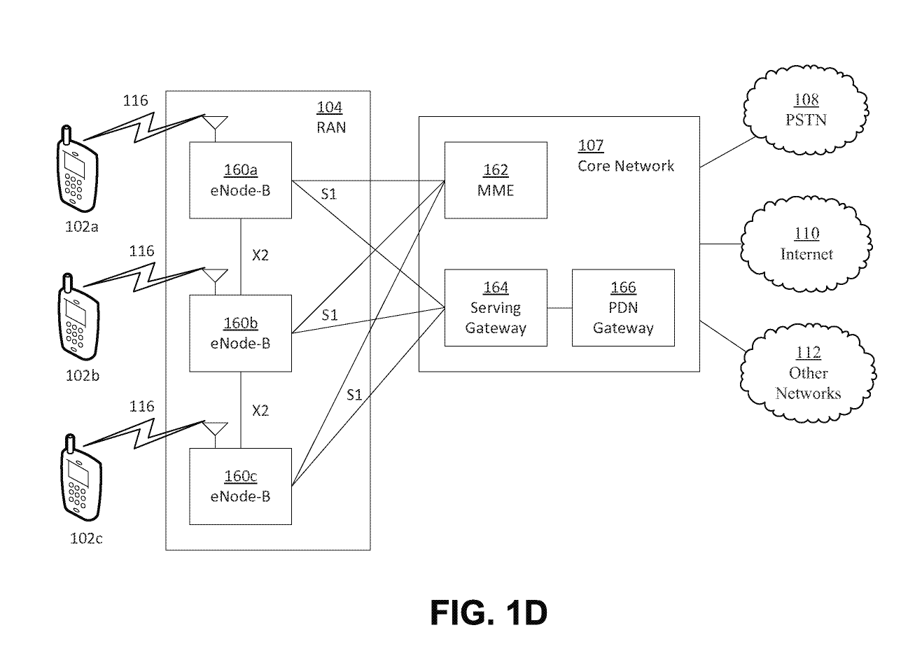

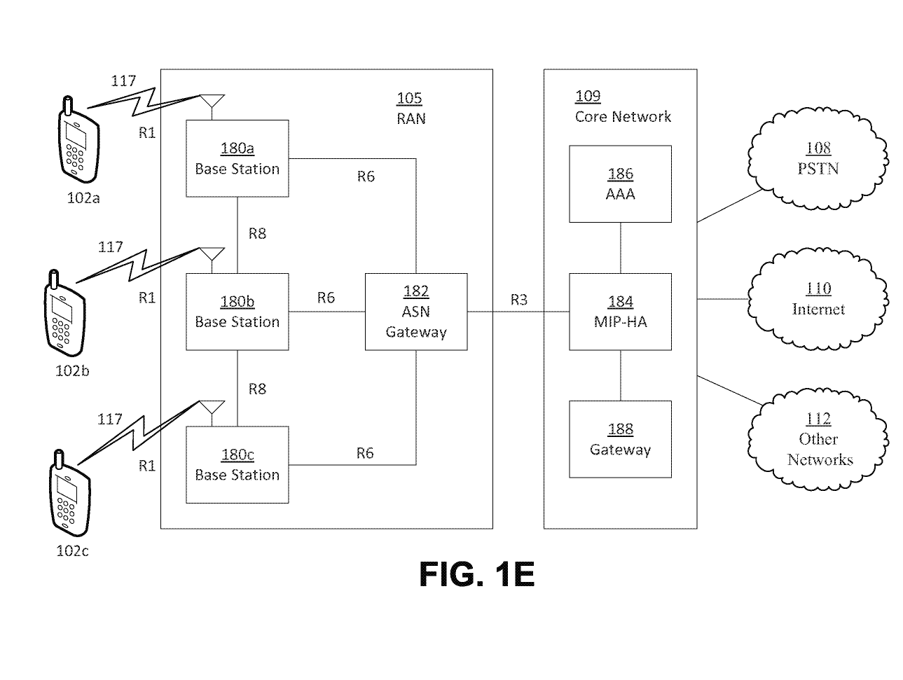

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include wireless transmit/receive unit (WTRU), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the, base station 114a may be divided into three sectors. Thus, in one embodiment, the base station 114a may include three transceivers, i.e., one for each sector of the cell. In an embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In an embodiment, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over interact protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the Internet protocol (IP) in the TCP/IP Internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In an embodiment, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the UPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Tub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro diversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Systems, methods, and instrumentalities are described herein that may provide an online and offline charging architecture associated with a converged gateway (CGW). The architecture may include interfaces to core network components, which may facilitate the charging.

An operator of a CGW may have an agreement with a content provider to allow for the delivery of content. The content provider or the CGW operator may be charged for the delivery of the content.

An operator of a CGW may be charged, where, e.g., the content provider and a mobile network operator or a combination of multiple operators may have an agreement to allow for the delivery of content. The method may allow charging of the content to an end user (e.g., a WTRU). The traffic related to the delivery of the content may not flow through the core network.

A CGW may inform the policy charging and rules function (PCRF) component in the core network that it may, for example, perform local IP flow mobility (IFOM). The CGW may send charging information to the core network, e.g., charging entities. A user receiving the data over different air interfaces may be charged. The charges may vary for each of the air interfaces. For example, data received over a cellular interface may be charged at a first rate, while data received over a WiFi interface may be charged at a second rate, e.g., may not be charged.

The methods, systems and instrumentalities discussed herein may be applicable to a 3G based core network and/or a 4G core network (e.g., an evolved packet core (EPC) network). The names of the network elements in the 3G based network and 4G based networks may vary. For example, the gateway GPRS support node (GGSN) in a 3G network may have an equivalent or comparable component in the packet domain network (PDN) gateway (PGW) in a 4G network. The charging elements and functions of each node may be comparable.

A network, e.g., a 4G LTE network may, for example, use the Diameter signaling protocol. In a network using the Diameter protocol, the attribute-value pairs (AVPs) may be reused or custom AVPs may be created. Other than the Diameter signaling protocol, other signaling protocols (e.g., GPRS Tunnel Protocol prime (GTP′), Remote Authentication Dial In User Service (RADIUS), Lightweight Directory Access Protocol (LDAP)) may be used. The message contents used may conform to the signaling protocol used.

Several CGW configurations may be described herein. The CGW may be integrated with a femtocell as a single unit. The CGW may be integrated into a single unit with a femtocell and a WiFi access point (AP). The CGW may be integrated with multiple femtocells of different radio access technologies, e.g., with or without a WiFi AP. The CGW may be standalone and may not be physically integrated with the femtocell(s) and/or WiFi AP(s). A femtocell may include, for example, femtocells, picocells, microcells, metrocells, and/or small cells.

The subject matter disclosed herein (e.g., subject matter illustrated with reference to a CGW) may be applied to an edge node entity that may be located between the access network and the core network, e.g., an entity other than a CGW. For example, the architecture, interfaces and/or methods described herein may be applied to a Local Gateway (LGW), such as Local Gateways associated with the Third Generation Partnership (3GPP) standards or may be applied to a Home (evolved) Node B. An edge node device may be located at the edge of an enterprise network or a metrocell deployment.

The architectures, interfaces, and methods proposed herein may support online and/or offline charging. The online and/or offline charging may use different interface names. The charging elements may be inside and/or outside the core network.

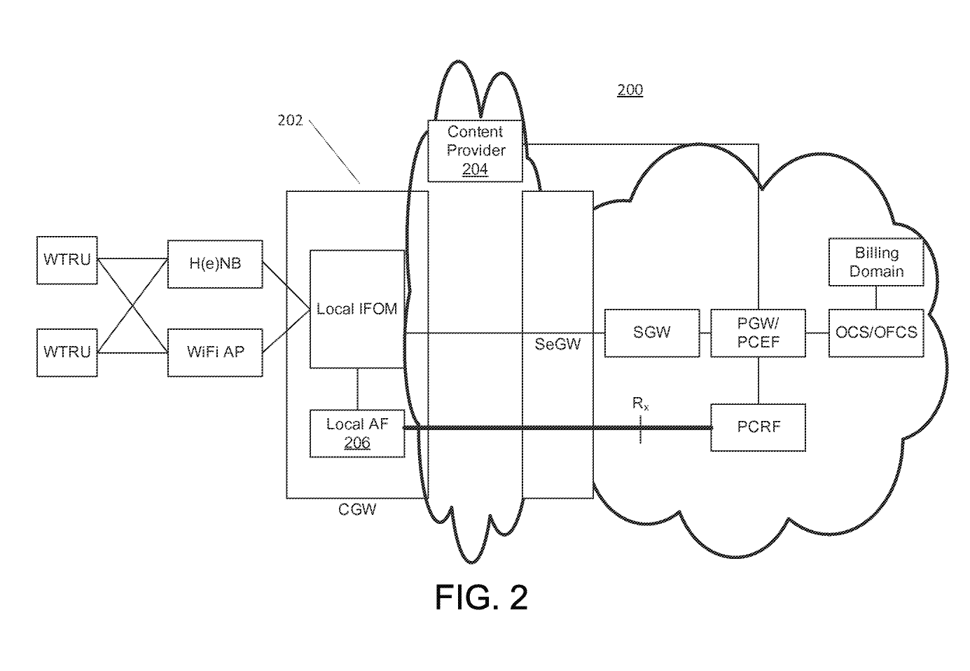

FIG. 2 illustrates an exemplary system 200 in which an operator of a CGW 202 may have an agreement with a content provider 204 to allow for the delivery of content that may be charged to the content provider 204 or some other entity. A user (e.g., a WTRU) connected via the CGW 202 may be allowed to preview the content. For example, a CGW operator may advertise to the user, free data access while the user is at their enterprise, campus and/or metro location, etc. The CGW 202 may include a local application function (AF) 206, e.g., to support the Rₓ interface. The AF 206 may comprise an element that may use, request, or perform dynamic policy and/or charging for IP flows associated with an application and/or a content and/or a type of content.

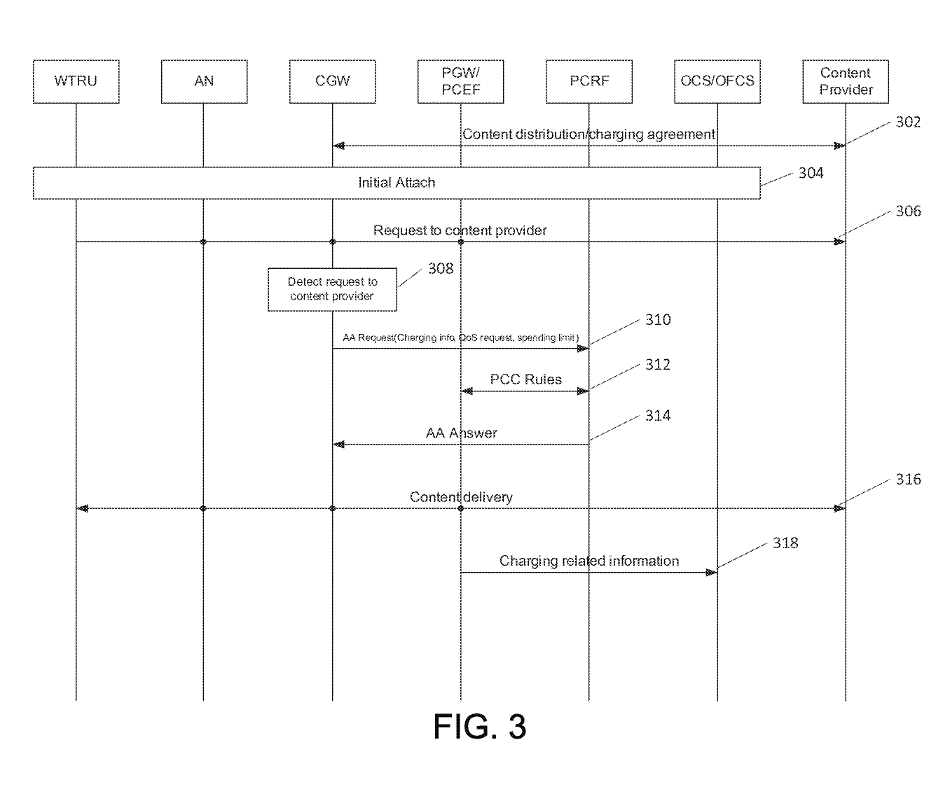

FIG. 3 illustrates an exemplary message sequence chart (MSC), e.g., for the exemplary architecture of the system 200 illustrated in FIG. 2. As illustrated in FIG. 3 at 302, the CGW operator and the content provider may have an agreement regarding who may pay for the delivery of content to end users that may be connected via the CGW. An end user device (e.g., a WTRU) may connect to the network, e.g., by performing an initial attach procedure at 304. As part of the initial attach procedure, the Wireless Transmit/Receive Unit (WTRU) may be assigned an IP address via the default bearer activation. The WTRU (e.g., end user via the WTRU) device may initiate a request towards the content provider at 306. For example, the end user (e.g., a WTRU) may enter a Uniform Resource Locator (URL) into a web browser. The request may pass through the CGW, which may detect the request at 308 (e.g., the request may be received and/or intercepted by the CGW). The CGW may recognize the recipient of the request, e.g., the content provider who has an agreement with the CGW operator. The CGW may send an authorization message, such as an authentication and/or authorization (AA) request message, e.g., over the Rₓ interface, to the PCRF at 310. The authentication and/or authorization message may include charging information, the WTRU identity, the quality of service (QoS) requirement(s), and/or the spending limit. The charging information may indicate the entity (e.g., the CGW or the content provider) that may be charged for the session. If specific resources are needed to deliver the content, the QoS requirement may be used to trigger the establishment of a dedicated bearer. The spending limit may be used to limit the amount of the data that may be allowed to flow before the PCRF may ask for re-authorization.

The PCRF may send Policy and Charging Control (PCC) rules to the PGW's policy and charging enforcement function (PCEF) at 312. These rules may include the service data flow (SDF) rules, and/or event triggers. The PCRF may acknowledge the authorization message, e.g., AA request message, by sending an AA answer message to the CGW at 314. The content may flow between the WTRU and the content provider. The data may traverse the PGW/PCEF, the CGW, and/or the access network (AN).

While the content is delivered to the end user (e.g., a WTRU) at 316, the PGW/PCEF may issue charging related messages to the online charging system (OCS), e.g., via the G_{y} interface and/or the offline charging system (OFCS), e.g., via the Gₐ or R_{f} interfaces at 318. The charging related messages may be issued, for example, when events are triggered or an IP flow is terminated.

If the data and/or time threshold expires, the CGW and/or PCRF may communicate to re-authorize the charging to allow additional content to be delivered. The end user (e.g., a WTRU) may download a preview of a content. The end user (e.g., a WTRU) and the content provider may negotiate, and the full content may be delivered to the end user (e.g., a WTRU). The CGW may indicate the re-authorization to the PCRF.

The CGW may indicate who is to be charged. The charging records may be generated by the PGW/PCEF. The charging may apply to online charging and/or offline charging.

As illustrated in FIG. 2, the Rₓ interface may be used to inform the PCRF as to the entity that may be charged for the delivery of certain content. The Rₓ interface/feature may be combined with a node that may detect the request from an end user (e.g., a WTRU) to a content provider. The content provider may not support the Rₓ interface or the interface to a node that may support the Rₓ interface, when the content is requested. In a system, for example that is 3GPP standard compliant, the content provider may provide an AF and/or an interface to an AF after the content is requested. The AF provided may not be part of the data path.

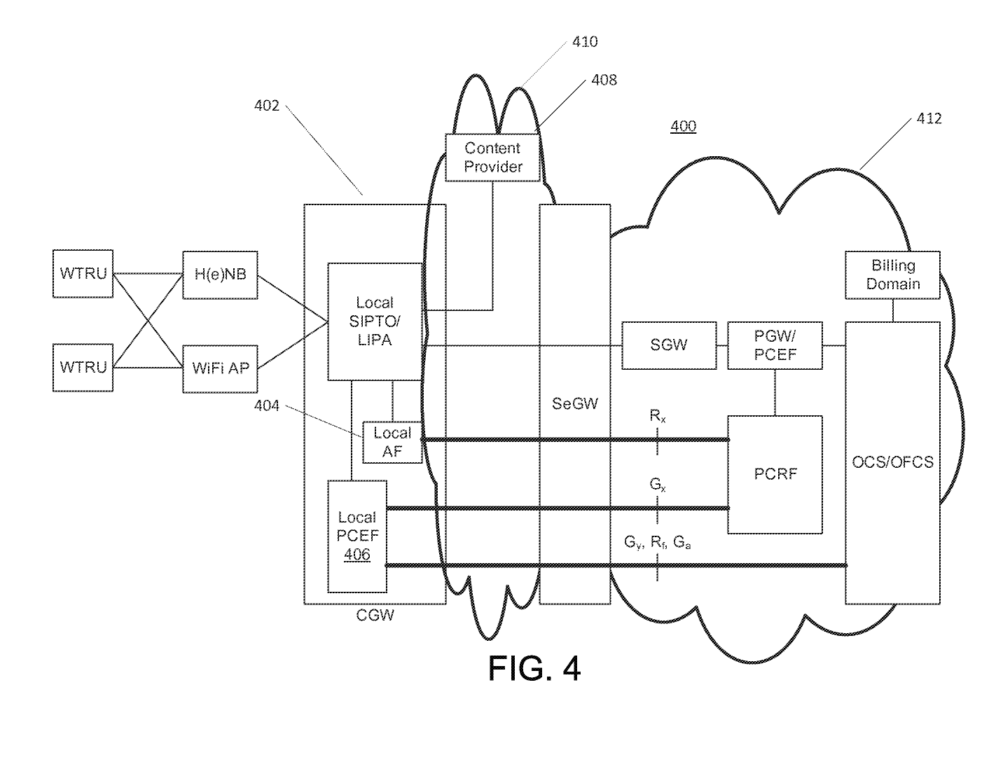

FIG. 4 illustrates an exemplary converged gateway system 400 with local selected IP traffic offload (SIPTO), and local IP access charging architecture. As illustrated in FIG. 4, a CGW 402 may include a local AF 404, and/or a local PCEF 406 to support, e.g., the Rₓ, Gₓ, G_{y}, R_{f}, and Gₐ interfaces. The CGW operator may have an agreement with a content provider 408, which may be connected to the Internet 410 to allow for the delivery and/or charging of content to an end user (e.g., a WTRU) without the traffic flowing through a core network 412. The end user (e.g., a WTRU), content provider 408, and/or the CGW operator may be billed for using the licensed spectrum to deliver the content to the end user (e.g., a WTRU). The content may be charged at a lower rate, as the mobile operator's licensed spectrum may be used (e.g., only the mobile operator's licensed spectrum may be used). In this architecture, the elements within the core network may not handle the data traffic.

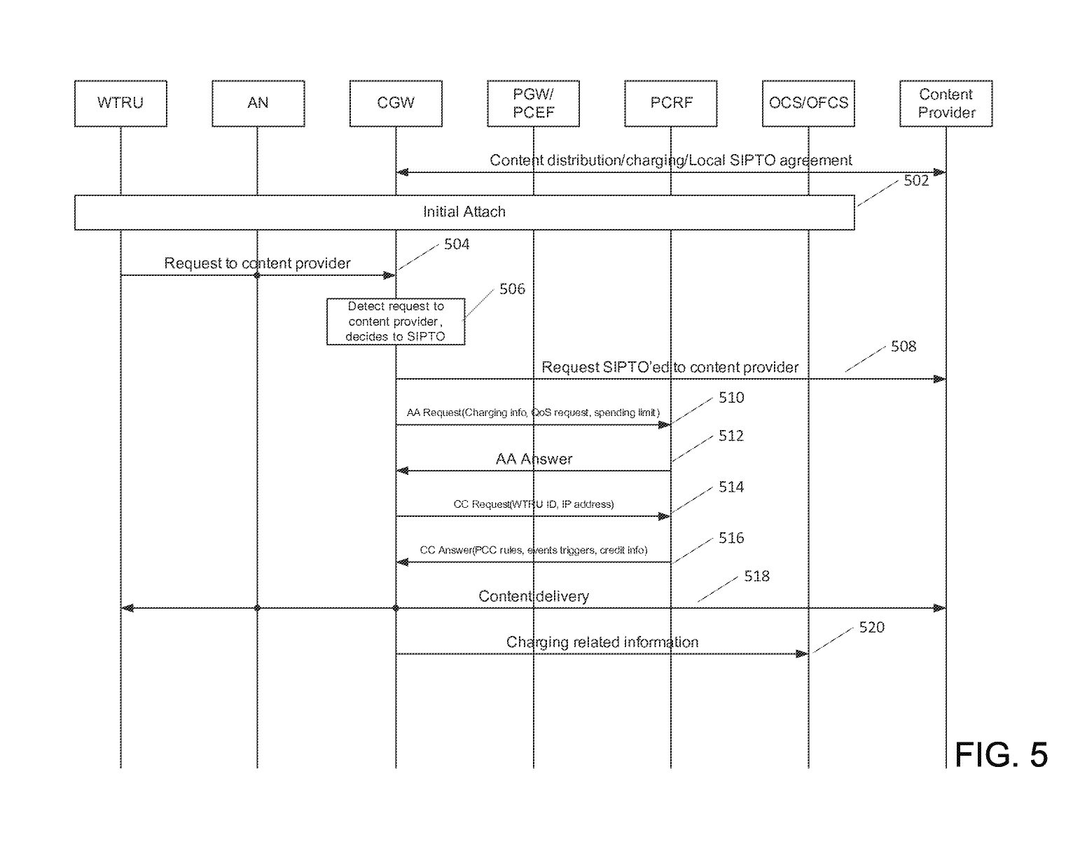

FIG. 5 illustrates an exemplary MSC, e.g., corresponding to the architecture illustrated in FIG. 4. An agreement may exist between the CGW operator and the content provider about the entity that may pay for the delivery of the content provider's content to end users (e.g., WTRUs) that may be connected via the CGW. The CGW operator and the content provider may have an agreement that traffic may be offloaded from the CGW onto the public Internet or to the content provider. The traffic may bypass the mobile core network. The scenario in which the mobile core network may be bypassed for the data plane may be free of charge for the end user (e.g., a WTRU). The operator may provide services, such as allowing the WTRU to connect via the core network (e.g., authentication, etc.), using the operators licensed spectrum (e.g., assuming the cellular air interface is used), providing billing services, etc. The end user (e.g., a WTRU) may be charged, for example, for these services.

An end user device (e.g., a WTRU) may connect to the network by performing a procedure, e.g., an initial attach procedure at 502. As part of this procedure, the WTRU may be assigned an IP address via the default bearer activation. The end user device (e.g., a WTRU) may initiate a request towards the content provider at 504. An example may include entering a URL into a web browser. The request may reach the CGW, which may detect the request at 506 (e.g., the request may be received and/or intercepted by the CGW). The CGW, e.g., based on the agreement with the content provider, may bypass the core network (e.g., via a non-cellular interface) and route the request directly to the content provider at 508.

The CGW may send an authorization message, such as an AA request, e.g., over the Rₓ interface, to the PCRF at 510. The message may include, for example, the charging information, the WTRU identity, the QoS requirement, the spending limit, etc. The charging information may indicate the CGW operator or the content provider to be charged for the session. If specific resources are needed to deliver the content, the QoS requirement may be used to trigger the establishment of a dedicated bearer. A spending limit may be used to limit the amount of data that may be allowed to flow before the PCRF may ask for re-authorization. The PCRF may acknowledge the authorization message, e.g., AA request message by sending an AA answer message to the CGW at 512.

The CGW may issue a credit control (CC) request message, e.g., over the Gₓ interface, to the PCRF at 514. The CC request message may include the WTRU ID, such as the international Mobile Subscriber ID (IMSI), and/or the IP address assigned to the end user device (e.g., a WTRU). The CGW may issue a CC request message using the international Mobile Equipment Identity (IMEI) of the end user device (e.g., a WTRU). The CC request message may enable device-type charging. AVPs may support this type of charging. The PCRF may send a CC answer message to the CGW at 516. This message may include the PCC rules, the event triggers, and/or the credit information. The PCC rules may indicate the triggers for events that may occur as the data session is in progress. The triggers, for example, may include, start and stop of an SDF, and the data and time thresholds. The CGW may request re-authorization or provide updated charging allowances.

The content may flow from the content provider to the WTRU at 518, via the CGW, bypassing the mobile core network. The CGW may issue charging related message(s) at 520 to the OCS within the core network, e.g., via the G_{y} interface, and/or to the OFCS within the core network, e.g., via the R_{f} or Gₐ interfaces. The CGW may issue charging related messages as the content is delivered. The issuing of charging related messages may repeat, e.g., periodically and/or on an ongoing basis, as the events are triggered and/or the IP flow is terminated. The charging may indicate the air interface that may be used, as the operator may charge based on whether licensed or unlicensed spectrum may be used to deliver the content.

If the data and/or time threshold expires, the CGW and/or PCRF may re-authorize the charging to allow additional content to be delivered. The end user (e.g., a WTRU) may download a preview of a content. The end user (e.g., a WTRU) and the content provider may negotiate, and the full content may be delivered to the end user (e.g., a WTRU). The CGW may indicate the re-authorization to the PCRF.

In the architecture illustrated in FIG. 4, the PCRF may provide the PCC rules to the CGW, e.g., via the Gₓ interface, for example, since the data traffic may not be traversing the PGW/PCEF. These rules may inform the CGW how to provide the charging information to the OCS and/or OFCS. The CGW may report usage statistics to the OCS and/or OFCS via the interfaces so that the appropriate entity may be charged. The CGW may keep track of the statistics for the OCS and/or OFCS. For example, it may keep track of the amount of data and/or the duration. The CGW may keep track of the statistics per SDF, for an IP Flow that may be offloaded by the CGW.

The CGW and the content provider may have an agreement about the traffic that may be offloaded by the CGW. A similar arrangement may be applied to the case where the CGW and core network may have an agreement about the traffic that may be offloaded, e.g., via SIPTO or local offload. The CGW and mobile core network may have an agreement about the traffic that may be offloaded via SIPTO, e.g., rather than the CGW and content provider. The mobile core network, the CGW, and the content provider, may have an agreement as to the traffic that may be offloaded via SIPTO. The exemplary converged gateway system with local selected IP traffic offload (SIPTO), as illustrated in FIG. 4 for example, may be applied to Local IP Access (LIPA) traffic.

In the architecture, for example, as shown in FIG. 4, the data traffic may be offloaded via SIPTO at the CGW. The data may not touch the core network elements (e.g., the SGW). The CGW may have one or more interfaces to the charging element or elements of the core network to perform charging for the offloaded traffic.

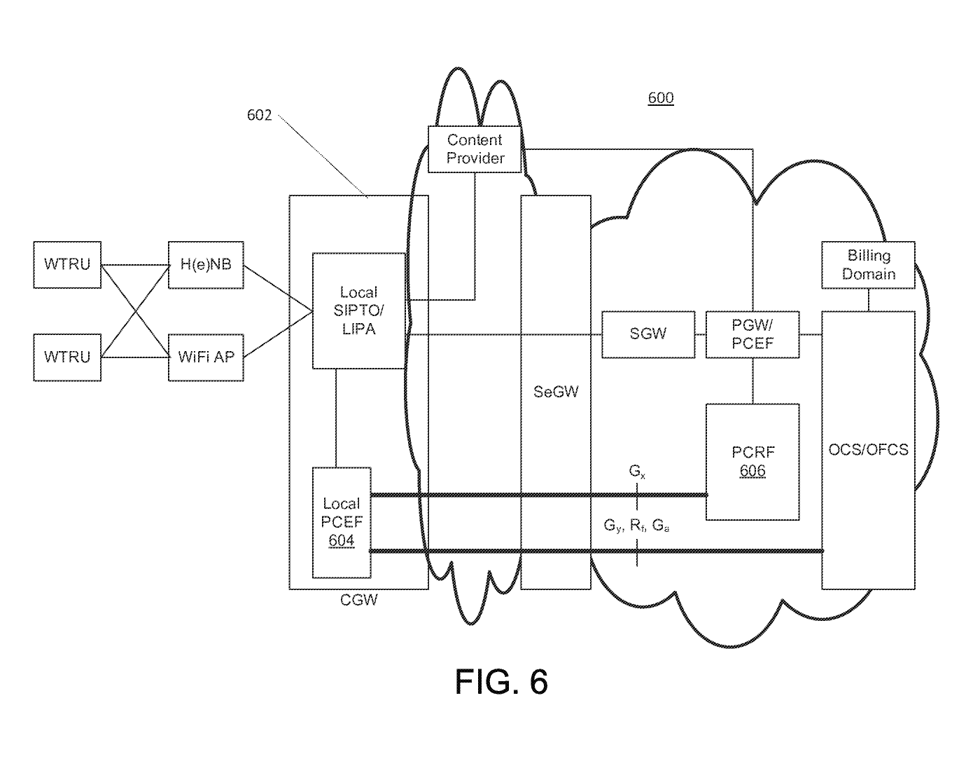

FIG. 6 illustrates an exemplary converged gateway system 600 with a local IP flow mobility charging architecture. A CGW 602 may include a local PCEF 604, e.g., to support the Gₓ, G_{y}, R_{f}, and Gₐ interfaces. The CGW 602 may inform a PCRF 606 that it may perform local IFOM. The CGW 602 may send charging information to the OCS and/or OFCS. The data may be sent over the cellular and/or WiFi interfaces and may be charged differently for each of the interfaces. For example, since the cellular interface uses the licensed spectrum, the tariff for the data sent over the cellular interface may cost more than the data sent over, for example, the unlicensed WiFi spectrum.

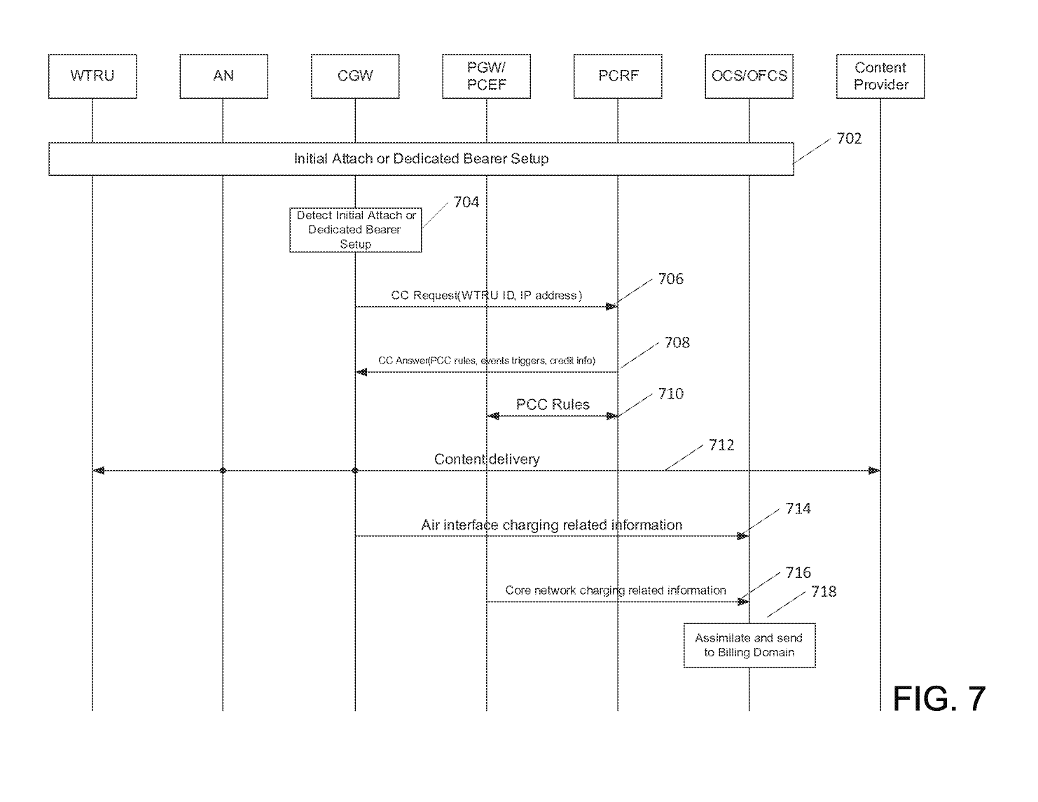

FIG. 7 illustrates an exemplary MSC corresponding to the architecture illustrated in FIG. 6. An end user device (e.g., a WTRU) may connect to the network via the initial attach procedure or an already connected WTRU may establish a dedicated bearer at 702. The CGW may detect these events occurring at 704. The CGW may perform local IFOM of IP Flows. The CGW may request charging information from the PCRF. The CGW may send a CC Request to the PCRF, e.g., over the Gₓ interface, at 706. The request message may include the WTRU ID, and/or the WTRU's IP address. The CGW may send other identifying characteristics of the WTRU. The PCRF, e.g., via the Gₓ interface, may send a CC answer message to the CGW including, for example, the PCC rules, event triggers, and/or the credit information at 708. The CGW may use the request message for charging purposes. The CGW may use the contents of the request message to attempt to initiate the creation of a dedicated bearer.

The PGW/PCEF may contact the PCRF for the PCC rules, e.g., via the Gₓ interface, between the PGW and the PCRF at 710. The PGW/PCFE may send a CC request message to the PCRF. The PCRF may respond with the PCC rules, e.g., via the Gₓ interface, using the CC answer message. The content may flow between the WTRU and the content provider at 712. The data may traverse the core network and the CGW, e.g., via the backhaul network. The data between the CGW and WTRU, over the AN, may use the cellular air interface and/or the WiFi air interface.

While the content may flow at 712, the CGW may inform the OCS, e.g., via the G_{y} interface, and/or the OFCS, e.g., via the R_{f} and/or Gₐ interfaces, of the amount of data used by each air interface for each SDF for this user at 714. The PGW/PCEF may inform the OCS, e.g., via the G_{y} interface, or the PFC, e.g., via the R_{f} or Gₐ interfaces, how much data has traversed the core network elements at 716.

The OCS and/or OFCS may combine the charging data received from, e.g., the CGW and/or PGW/PCEF to create billing records at 718. The OCS and/or OFCS may push the billing record to the billing domain. The CGW may support the Gₓ interface to the PCRF, the G_{y} interface to the OCS, and R_{f} and Gₐ interfaces to the OFCS. The CGW may track the transport that may be used for the SDFs, the duration of the connection, and the amount of data that may be transmitted and received for each SDF. The CGW may report the charging events as configured by the PCRF. For example, the CGW may report the start/stop of a SDF, the timer expiry or value threshold reached, and/or the re-authorization events.

The PGW/PCEF and/or the CGW may report billing events for a WTRU. The PGW/PCEF may report the usage of the core network components, e.g., the PGW and/or the SGW, and the CGW may report on the use of the air interface. The billing records, e.g., the related billing records may be combined within the OCS and/or OFCS in a number of ways. The OCS and/or OFCS may use the reports from the CGW, e.g., based on the air interface used. The CGW may use the reports from the PGW/PCEF, e.g., based on the core network resources used. The total charge for a user may be a function of the used spectrum (e.g., licensed versus unlicensed) and how much data may have travelled through the core network. For example, the charge for unlicensed spectrum use may be lower than for the licensed spectrum.

The CGW may report the amount of traffic traversing the core network and the spectrum usage. An interface on the CGW may interact with the PGW/PCEF. The CGW may report billing information for a user and/or a data session. The CGW may report the spectrum usage to the PGW/PCEF over an interface. The PGW/PCEF may report, to the OCS and/or OFCS, the charging information related to both the spectrum usage and the amount of traffic that may pass through the network. If the WTRU detaches from the core network or the network detaches the WTRU, the CGW configuration supporting the interfaces to the core network may inform the PCRF and/or the OCS and/or OFCS to end the charging session.

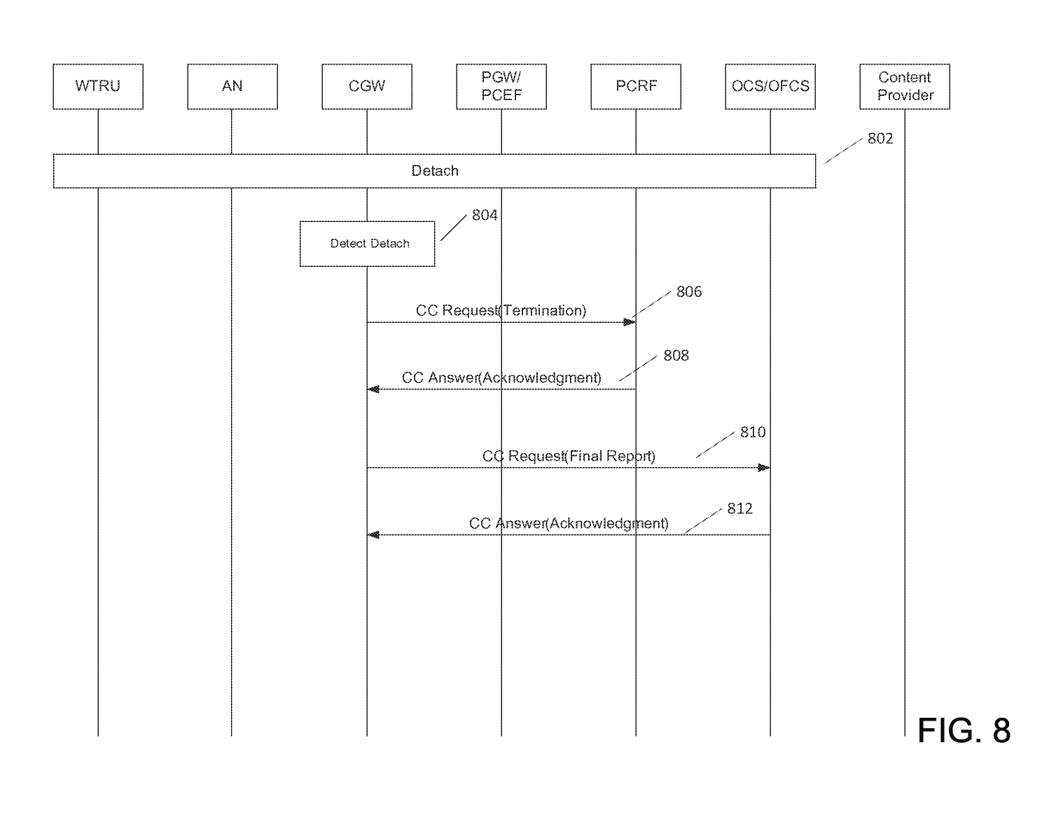

FIG. 8 illustrates an example of converged gateway processing for a WTRU detach. The WTRU or the network may initiate the detach procedure at 802. The CGW may detect the detach at 804 and may send a CC Request indicating the termination at 806 to the PCRF, e.g., over the Gₓ interface. The PCRF may respond at 808 with a CC answer, e.g., acknowledging the termination. The CGW may send a CC request to the OCS and/or OFCS, e.g., over the G_{y} interface at 810. This request message may include a report (e.g., a final report) for billing purposes. The OCS and/or OFCS, e.g., over the proper interface, may issue a CC answer acknowledgement at 812. If the CGW has an interface to the OCS and/or OFCS, the PCRF may issue PCC rules to the CGW. If the PCRF changes the rules, it may issue a re-authorization (RA) request message to the CGW, e.g., over the Gₓ interface. The RA request message may include the PCC rules and event triggers. The CGW, upon receiving the request message, may respond with a RA answer message, e.g., over the Gₓ interface, confirming the receipt of the RA request message.

In the example architectures illustrated in FIGS. 2, 4 and 6, the charging elements may be placed within the EPC. In other architectures, for example, one or more of the charging elements may be placed within the CGW or on the public Internet.

The CGW may be connected (e.g., directly connected) to the billing domain, e.g., via the Bₚ interface. The CGW may have a local OCS and/or OFCS connected to the billing domain. The CGW may format the CDRs and upload the formatted CDRs to the billing domain via a network protocol, for example, file transfer protocol (FTP).

The CGW may have some components of the OCS and/or OFCS within the CGW. The OCS and/or OFCS charging path may include the Charging Trigger Function (CTF), Charging Data Function (CDF) and Charging Gateway Function (CGF). The CGW may comprise various combinations, for example, CTF (e.g., where the CDF and CGF may be in the core network), CTF and CDF (e.g., where the CGF may be in the core network), and/or CTF, CDF, and CGF (e.g., where the CGW interfaces may be connected (e.g., directly connected) to the billing domain).

The CGW may support 3GPP standard compliant interfaces for these devices. When the CTF, CDF, CGF, or a combination of these functions is included within the CGW, they may be referred to as local CTF, local CDF, and/or local CGF, respectively. If a local CTF is included in the CGW, the interface between the CGW and the core network may be the R_{f} interface. If both the CTF and CDF are included in the CGW, the interface between the CGW and the core network may be the Gₐ interface. If the functions are included in the CGW, the interface between the CGW and the core network is the Bₚ interface.

The application layer protocol, e.g., Diameter and/or GPRS Tunnel Protocol prime (GTP′), may be used to transport messages between the CGW and the charging entities within the core network. The charging entities within the core network may be Diameter and/or GTP′ capable. Other protocols used may include, e.g., Remote Authentication Dial In User Service (RADIUS) protocol, Lightweight Directory Access Protocol (LDAP), Hypertext Transfer Protocol (HTTP) protocol, 3GPP standard protocol, and/or a proprietary application layer protocol.

The transport layer protocol may be Transmission Control Protocol (TCP) or Stream Control Transmission Protocol (SCTP). Reliable delivery may be used to transport messages between the charging entities. Other transport protocols used may include, e.g., User Datagram Protocol (UDP). A reliable transmission/reception of packets may be added at the application layer protocol. For the Internet layer, IP may be used. Internet protocol security (IPSec) may be used to ensure a secure tunnel between the CGW and the charging elements within the core network. The CGW may be located outside the core network and the charging entities interfacing the CGW may be placed inside the core network. The interfaces between the CGW and the charging entities may be secured.

The CGW may have an IPSec tunnel into the core network via, e.g., the SeGW. The tunnel may be used to carry the charging interfaces between the CGW and the charging entities, e.g., PCRF, PCEF, OCS, OFCS, and/or the billing domain. The CGW and the charging entities may authenticate (e.g., mutually authenticate) each other using, for example, certificates and/or keys to establish a trusted, secure connection. For example, Secure Sockets Layer (SSL), Secure HTTP (HTTPS), or a secure connection protocol may be used. To secure the charging interfaces, other security methods may be used, e.g., the CGW may be physically secured to make it tamper-resistant or tamper-proof.

If a CGW is managing several femtocells and/or APs, a number of messages may be exchanged between the CGW and the charging entities. The messages from the CGW to the charging elements may be compressed. The charging elements may decompress the compressed messages.

A network may have redundant charging elements, e.g., there may be one or more of the PCRFs, PGW/PCEFs, CDFs, CTFs, and/or CGFs. The CGW may support interfaces to one or more of these elements, e.g., simultaneously. The CGW may be consistent, e.g., the CGW may start reporting charging information of a network element for a particular SDF. The CGW may continue reporting to the same network element for the same SDF and/or subscriber.

The location of the charging elements may be provisioned on the CGW. The provisioning may include, e.g., the IP addresses and/or Fully Qualified Domain Names (FQDNs) of the charging elements. If FQDNs are used, the CGW may resolve the FQDNs, for example, by querying a Domain Name System (DNS) server.

The CGW may be pre-programmed with this FQDN information at the time of manufacture. The CGW may be provisioned as part of an Operations, Administration and Management (OAM) provisioning of the CGW. A provisioning element may send the FQDNs to the CGW. The CGW may resolve the FQDNs. The provisioning element may be inside or outside the core network. The charging elements may be pre-provisioned with the identity (e.g., FQDN) of the connecting CGWs. The CGW may register to an entity within the core network, indicating its capability of providing charging services. The indication may provide information about the presence of the CGW in the core network.

The methods, systems, and instrumentalities described herein may be used in an edge-based entity, for example, sitting between the access networks, the WiFi Access Point (AP) and the home eNodeB (HeNB), and/or the core network elements (SeGW, SGW, PGW, PCRF, OCS and/or OFCS). The methods, systems, and instrumentalities may be applied to a 3GPP standard based IP flow mobility that may be anchored and/or performed in the packet gateway (P-GW).

The CGW may support a plurality of interfaces and protocols, including, for example, the Gₓ interface, the G_{y} interface, the Rₓ interface, the R_{f} interface, and/or the Gₐ interface. The Gₓ, G_{y}, Rₓ, and R_{f} interfaces may support the Diameter protocol. The Gₐ interface may support the GTP′ protocol. The CGW may support a Bₚ interface. The Bₚ interface may support the FTP protocol.

At the transport layer, the CGW may support TCP and SCTP protocols. At the IP layer, the CGW may support IPSec or an equivalent protocol. For online and offline charging, the CGW may support credit control and credit management. The CGW may be able to request reservation of charging units before service delivery. The CGW may support event charging (e.g., immediate event charging), event charging with unit reservations, and/or session charging with unit reservation.

The CGW may report charging events, including, but not limited to: start/stop of SDFs, timer expiry or volume threshold, re-authorization events, and/or the change of air interface. The CGW may support an agreement with a content provider, and/or mobile network operator related to charging. The CGW may detect traffic using the 5-tuple of the data packets, and may compare the 5-tuple of the data packet with the PCC rules received from the PCRF. The 5-tuple may include, for example source IP address, destination IP address, source port number, destination port number and the protocol in use. The CGW may keep track of the volume and duration of traffic for each of the 5-tuple over an air interface. The CGW may accept PCC rules from the PCRF. The CGW may request the PCC rules and/or the PCRF may push them to the CGW. The CGW may detect when a WTRU attaches to the core network. The CGW may detect when a dedicated bearer may be established for a WTRU. The CGW may detect when a WTRU may detach or may be detached by the core network. The CGW may perform local SIPTO, local IFOM, and/or LIPA. The CGW may support compression of messages. The CGW may be tamper-resistant.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, optical media such as CD-ROM disks, and digital versatile disks (DVDs). A processor in association with software may be used to implement a radio frequency transceiver for use in a WTRU, WTRU, terminal, base station, RNC, or any host computer.

1.-26. (canceled)

27. A method for offloading traffic, the method comprising:
sending, via a gateway device, a request to a content provider bypassing a cellular core network;
sending a first authorization message associated with the request to a policy and charging rules function (PCRF) entity;
receiving traffic associated with the request from the content provider that bypasses the cellular core network; and
sending a charging message to a charging entity.

28. The method of claim 27, further comprising:
sending a credit control message to the PCRF entity; and
receiving an acknowledgement of the credit control message from the PCRF entity.

29. The method of claim 28, wherein the credit control message comprises one or more of an identity associated with a wireless transmit/receive unit (WTRU) or an IP address associated with the WTRU.

30. The method of claim 27, wherein the first authorization message comprises one or more of charging information, a spending limit, an identity associated with the wireless transmit/receive unit (WTRU), or a QoS requirement.

31. The method of claim 27, further comprising:
detecting the request from a wireless transmit/receive unit (WTRU), wherein the request is associated with the content provider; and
receiving an acknowledgement of the first authorization message from the PCRF entity.

32. The method of claim 27, further comprising sending a second authorization message to the PCRF entity in response to expiration of at least one of a data threshold or a time threshold.

33. The method of claim 27, wherein the charging entity is an online charging system (OCS) entity or an offline charging system (OFCS) entity.

34. A gateway device configured to:
send a request to a content provider bypassing a cellular core network;
send a first authorization message associated with the request to a policy and charging rules function (PCRF) entity;
receive traffic associated with the request from the content provider that bypasses the cellular core network; and
send a charging message to a charging entity.

35. The gateway device of claim 34, wherein the gateway device is further configured to:
send a credit control message to the PCRF entity; and
receive an acknowledgement of the credit control message from the PCRF entity.

36. The gateway device of claim 35, wherein the credit control message comprises one or more of an identity associated with a wireless transmit/receive unit (WTRU) or an IP address associated with the WTRU.

37. The gateway device of claim 34, wherein the first authorization message comprises one or more of charging information, a spending limit, an identity associated with a wireless transmit/receive unit (WTRU), or a QoS requirement.

38. The gateway device of claim 34, further configured to:
detect the request from a wireless transmit/receive unit (WTRU), wherein the request is associated with the content provider; and
receive an acknowledgement of the first authorization message from the PCRF entity.

39. The gateway device of claim 34, wherein the gateway device is further configured to send a second authorization message to the PCRF entity in response to expiration of at least one of a data threshold or a time threshold.

40. The gateway device of claim 34, wherein the gateway device is further configured to send a second authorization message to the PCRF entity when a spending limit is reached.

41. The gateway device of claim 34, wherein the charging entity is an online charging system (OCS) entity.

42. The gateway device of claim 34, wherein the charging entity is an offline charging system (OFCS) entity.

43. The gateway device of claim 34, wherein the charging message indicates which of a plurality of interfaces was used to deliver the traffic.

44. The gateway device of claim 34, wherein the charging message indicates that traffic delivered from a wireless transmit/receive unit (WTRU) to the content provider bypassed the cellular core network.

45. The gateway device of claim 34, wherein a charging request is sent using an Rₓ interface and the charging message is sent using a G_{y} interface.

46. The gateway device of claim 34, wherein the gateway device is further configured to send the traffic toward a wireless transmit/receive unit (WTRU).
